(19) United States
(12) Patent Application Publication
(10) Pub. No.: US 2018/0157071 A1
(43) Pub. Date: Jun. 7, 2018

(54) LIQUID CRYSTAL DISPLAY PANEL

(71) Applicants: Shenzhen China Star Optoelectronics Technology Co., Ltd., Shenzhen (CN); Wuhan China Star Optoelectronics Technology Co., Ltd., Wuhan (CN)

(72) Inventors: Cong WANG, Shenzhen (CN); Peng Du, Shenzhen (CN)

(73) Assignees: Shenzhen China Star Optoelectronics Technology Co., Ltd., Guangdong (CN); Wuhan China Star Optoelectronics Technology Co., Ltd., Hubei (CN)

(21) Appl. No.: 14/907,886

(22) PCT Filed: Dec. 7, 2015
(86) PCT No.: PCT/CN2015/096545

§ 371 Date: Feb. 23, 2018

(30) Foreign Application Priority Data
Nov. 19, 2015 (CN) 201510812472.1

(51) Int. Cl. G02F 1/1339; G02F 1/1362; G02F 1/1335; G02F 1/1333

(52) U.S. Cl. CPC G02F 1/1339; G02F 1/136286; G02F 1/133514; G02F 1/133345; G02F 1/133512

(57) ABSTRACT

Disclosed is a liquid crystal display panel. An array substrate of the liquid crystal display panel comprises at least two pixel units. One pixel unit comprises: a scan line extending along a first direction; a data line extending along a second direction, different from the first direction; a pixel electrode; and a thin film transistor which is disposed in a functional connection between the data line and the pixel electrode. At least a part of the two adjacent pixel units are arranged mirror-symmetrically to each other. A new wire design is provided, so that a spacer can be arranged to avoid a PLN via hole, which effectively prevents the spacer of the panel from sliding into the PLN via hole while a liquid crystal cell is assembled or during a bending test procedure.

### CROSS-REFERENCE TO RELATED APPLICATIONS

The present application claims the priority of Chinese patent application CN201510812472.1, entitled “Liquid crystal display panel” and filed on Nov. 19, 2015, the entirety of which is incorporated herein by reference.

### FIELD OF THE INVENTION

The present disclosure relates to the technical field of display, and in particular, to a liquid crystal display panel.

### BACKGROUND OF THE INVENTION

FIG. 1 shows a liquid crystal display panel in the prior art. As shown in FIG. 1, in a region of an array substrate of the liquid crystal display panel where a thin film transistor is arranged, a first glass substrate 1 is provided with a Light Shield (LS) structure 2 thereon for preventing light leakage therefrom. The Light Shield structure 2 is covered with a buffer layer 3. A Low Temperature Polysilicon 4 is arranged on the buffer layer 3. The Low Temperature Polysilicon 4 acts as a semiconductor channel in the transistor. The buffer layer 3 can block electrical connection between the Light Shield structure 2 and the Low Temperature Polysilicon Layer 4. The Low

Temperature Polysilicon Layer (LTPS) 4 is divided into a plurality of regions with different degrees of doping, such as a heavily doped region, a lightly doped region and an undoped region. The Low Temperature Polysilicon 4 is connected to a source 8 and a drain 9 of the thin film transistor. A Gate Insulator (GI) 5 is arranged on the Low Temperature Polysilicon 4. A gate 6 of the thin film transistor is arranged on the Gate Insulator (GI) 5. The Gate Insulator 5 is used to prevent electrical connection between the gate 6 and the Low Temperature Polysilicon 4. An Interlayer Dielectric (ILD) 7 is provided between the gate 6 and the source 8, the drain 9 of the thin film transistor. The source 8 and the drain 9 of the thin film transistor are covered with a PLN insulating layer 10. As shown in FIG. 1, in a region of the array substrate of the liquid crystal display panel where no thin film transistor is arranged, the first glass substrate 1 is covered with the buffer layer 3. A first insulating layer 5 which is in a same layer as the Gate Insulator 5 is arranged on the buffer layer 3. A second insulating layer 7 which is in a same layer as the Interlayer Dielectric 7 is arranged on the first insulating layer 5. A third insulating layer 10 which is in a same layer as the PLN insulating layer 10 is arranged on the second insulating layer 7. A common electrode layer 11 is arranged on the third insulating layer 10. An electrode insulating layer 12 is arranged on the common electrode layer 11. A pixel electrode layer 13 which is connected with the drain 9 of the thin film transistor is arranged on the electrode insulating layer 12. The electrode insulating layer 12 serves to prevent electrical connection between the common electrode layer 11 and the pixel electrode layer 13. The pixel electrode layer 13 is connected to the drain 9 of the thin film transistor through a via hole 19.

On a color filter substrate of the liquid crystal display panel, a second glass substrate 18 is provided with a black matrix 17 on a certain position thereof for blocking light leakage. The black matrix 17 and the second glass substrate 18 are covered with a color barrier layer 16. A protective layer 15 is provided on the color barrier layer 16. On the protective layer 15, a spacer 14 is provided at a specific position of the color filter substrate. The spacer 14 is used to keep a distance between the two substrates of a liquid crystal cell.

It can be seen that, in a manufacturing procedure of a conventional Low Temperature Polysilicon (LTPS) panel, a layer of cylindrical photo spacer (PS) 14 is deposited on one surface of the color filter substrate for supporting an upper substrate, so that a certain cell thickness (namely cell gap) can be formed between upper and lower substrates. The spacer 14 is generally positioned at an intersecting point of a row and a column of the black matrix (BM) in an active area (AA) of the panel, so as to avoid loss of pixel aperture ratio.

In the pixels of the substrate of the thin film transistor array, the PLN hole 19 for connecting the drain 9 and the pixel electrode 13 is quite large. The spacer 14 can easily slide into the PLN hole 19 due to the small distance between the spacer 14 and the PLN hole 19 when the liquid crystal cell are assembled or bent, which would lead to uneven thickness of the center substrate and abnormal display. The larger the number of pixel per inch (PPI) is, the smaller the distance between the spacer 14 and PLN hole 19 is, and the greater the probability that the spacer 14 slides into the PLN hole 19 is.

### SUMMARY OF THE INVENTION

Directed against the above technical problem in the prior art, i.e., due to the small distance from the spacer to the PLN hole, the spacer can easily slide into the PLN hole, which would lead to uneven thickness of the center substrate and abnormal display, the present disclosure provides an improved liquid crystal display panel.

The present disclosure provides a liquid crystal display panel. The array substrate of the liquid crystal display panel comprises at least two pixel units, and each pixel unit comprises: a scan line extending along a first direction; a data line extending along a second direction different from the first direction; and a thin film transistor, wherein at least a part of the two adjacent pixel units are arranged mirror-symmetrically to each other. The thin film transistor is arranged in a functional connection between a pixel electrode and the data line. That is, a connection between the gate and the drain of the thin film transistor is controlled by a gate switch, so that signals of the data line can be duly transmitted into the pixel electrode.

The present disclosure provides a novel design of the panel wiring, so that the spacer can avoid the PLN via hole, which effectively prevents the spacer of the panel from sliding into the PLN via hole while the liquid crystal cell is assembled or during a bending test procedure.

According to one embodiment, two adjacent pixels in the second direction are mirror-symmetrically arranged such that their scan lines extend parallel, and a symmetry plane is perpendicular to a surface of the array substrate and parallel to the scan line. According to the present embodiment, an n^{th} and an (n+1)^{th} scan lines of two vertically adjacent pixel units are arranged adjacent to each other, and the two adjacent parallel extending scan lines respectively control the pixels on a row above and on a row below. Compared with the liquid crystal display panel in the prior art, a position of the spacer does not change, and a limitation of a first via hole can be well avoided.

According to one embodiment, a source of the thin film transistor is connected to the data line while a drain of the thin film transistor is connected to a pixel electrode through a first via hole. The first vial hole runs through an insulating layer and a common electrode layer which are arranged between the drain and the pixel electrode. The source is connected to the drain through a channel structure, and the channel structure runs over the scan line. In this manner, the switching function of the thin film transistor can be ensured.

According to one embodiment, in the second direction, the extended paths of the channel structure of the two adjacent pixel units are mirror-symmetrically arranged with each other and connected to each other to form an H-shaped pattern together, and the scan line runs over the four opposite edges of the H-shaped pattern. In this manner, the complexity of the entire wiring layout can be reduced, and the time consumption of the manufacturing procedure and material costs thereof can be effectively reduced.

According to one embodiment, the first via holes of the two adjacent pixel units are combined into one via hole so that the first via hole passes the drain of the two adjacent pixel units when viewed in a plan view. In this manner, the manufacturing complexity and error risk can be greatly reduced.

According to one embodiment, a color filter substrate of the liquid crystal display panel is provided with a spacer for keeping a liquid crystal gap thereon. A position of the spacer corresponds to one end of the pixel unit of the array substrate in the second direction far from the symmetry plane. In this manner, it can be ensured that the position of the spacer does not change relative to the liquid crystal display panel in the prior art. The spacer can hardly slide into the first via hole while the liquid crystal cell is assembled, and the uniformity of the liquid crystal gap can be ensured.

According to one embodiment, two adjacent pixel units in the first direction are minor-symmetrically arranged such that their data lines extend in parallel. A symmetry plane is perpendicular to a surface of the array substrate and parallel to the data line. According to the present embodiment, the data lines of two horizontally adjacent pixel units are arranged adjacent to each other. At this time, a distance between two data lines which are far from each other is 2p (p is a pixel unit size in the first direction).

According to one embodiment, a source of the thin film transistor is connected to the data line. A drain of the thin film transistor is connected to a pixel electrode through a first via hole, and the source is connected to the drain through a channel structure. The channel structure runs over the scan line. In this manner, the switching function of the thin film transistor can be ensured.

According to one embodiment, the color filter substrate of the liquid crystal display panel is provided with a spacer for keeping a liquid crystal gap thereon. A position of the spacer corresponds to one end of the pixel unit of the array substrate in the first direction far from the symmetry plane. In this manner, it can be ensured that the position of the spacers does not change relative to the liquid crystal display panel in the prior art.

According to one embodiment, in the first direction, a distance between the first via hole and the end of the pixel unit far from the symmetry plane is larger than an alignment accuracy of a liquid crystal cell. At this time, the distances between the spacer and the via holes on both sides are d2. During pixel design, as long as it can be ensured that the value of d2 is larger than the alignment accuracy of the liquid crystal cell, it can be ensured that the spacer will not slide into the first via hole when the liquid crystal cell is assembled.

According to the embodiments of the present disclosure, the uniformity of the thickness of the liquid crystal cell can be effectively guaranteed, and display performance of the panel can be improved. Meanwhile, it can realize the import of PLN negative photoresist material, so as to reduce the costs.

The above technical features can be combined in any suitable manner, or substituted by the equivalent technical features, as long as the purpose of the present disclosure can be achieved.

### BRIEF DESCRIPTION OF THE DRAWINGS

The present disclosure will be illustrated in detail hereinafter with reference to the embodiments and the accompanying drawings. In the drawings:

FIG. 1 shows a longitudinal sectional view of a liquid crystal display panel in the prior art;

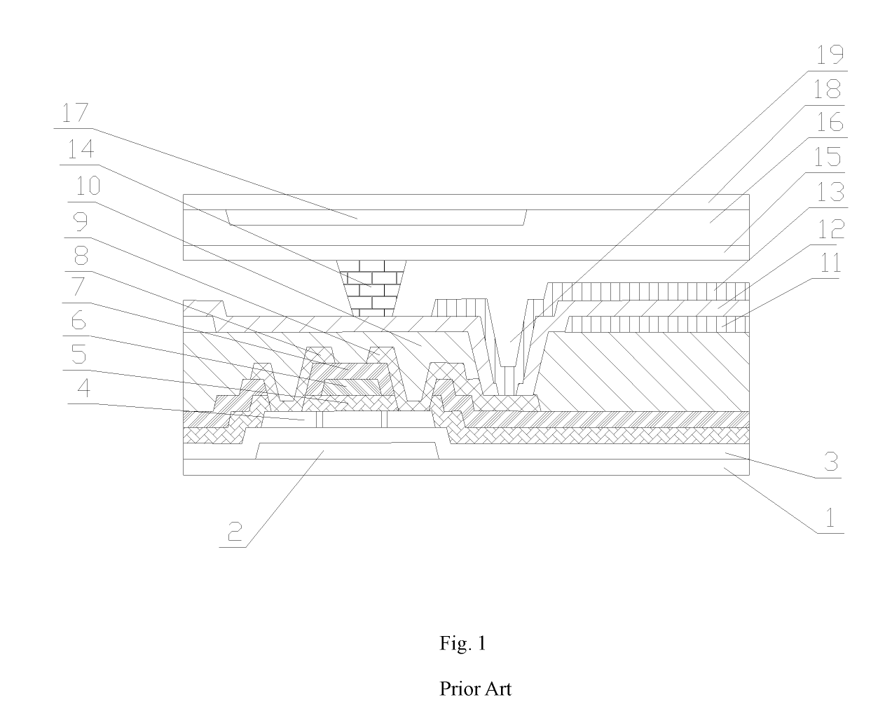

FIG. 2 shows a top view of partial structure of a liquid crystal display panel in the prior art;

FIG. 3 shows an enlarged drawing of the circle in FIG. 2;

FIG. 4 shows a top view of a partial structure of a liquid crystal display panel according to a first embodiment of the present disclosure;

FIG. 5 is a partial enlarged drawing of FIG. 4;

FIG. 6 shows a top view of a partial structure of a liquid crystal display panel according to a second embodiment of the present disclosure; and

FIG. 7 is a partial enlarged drawing of FIG. 6.

In the drawings, the same components are indicated with the same reference signs. The figures are not drawn in accordance with an actual scale.

### DETAILED DESCRIPTION OF THE EMBODIMENTS

The present disclosure will be further explained hereinafter in combination with the accompanying drawings.

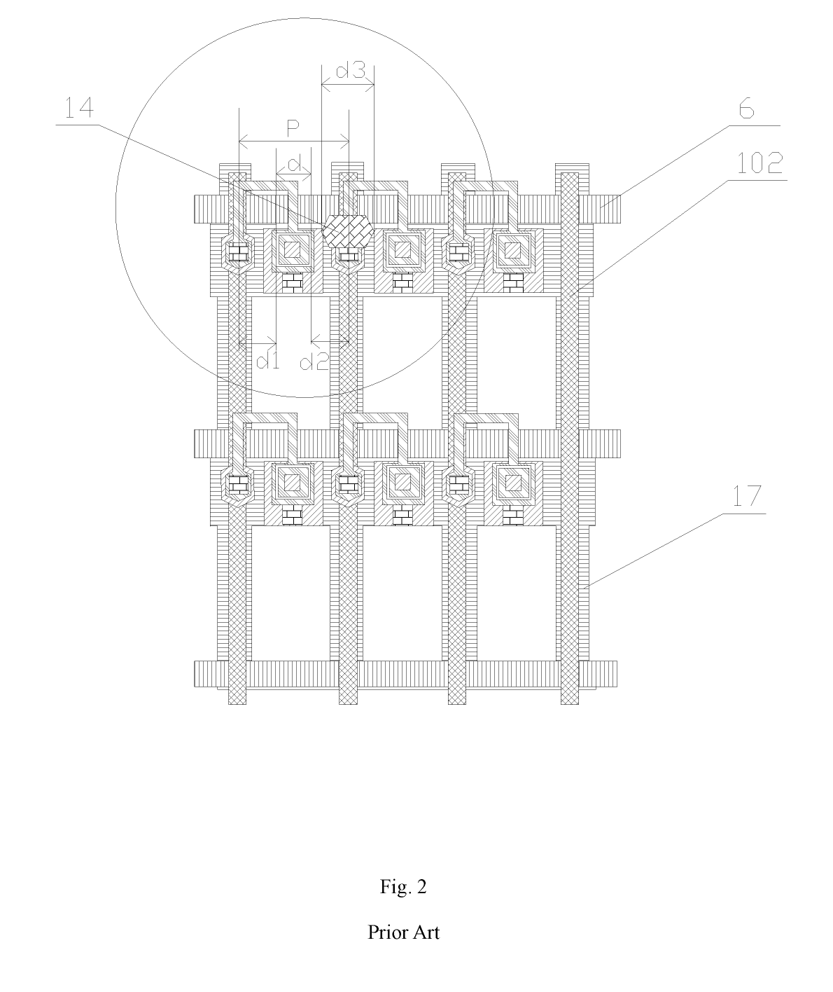

FIG. 2 shows a top view of a partial structure of a liquid crystal display panel in the prior art. FIG. 2 clearly shows that, an array substrate of the liquid crystal display panel in the prior art comprises a pixel unit 30 (not shown in FIG. 2). Each pixel unit 30 comprises: a scan line 6 extending along a first direction (a horizontal direction in FIG. 2); a data line 102 extending along a second direction (a vertical direction in FIG. 2) different from the first direction; an optional pixel electrode (not shown in FIG. 2); and a thin film transistor, which is disposed in a functional connection between the pixel electrode and the data line 102. A black matrix 17 is provided at a position corresponding to the scan line 6 and the data line 102 for blocking light leakage therefrom. The pixel electrode can be disposed in a region surrounded by the scan line 6 and the data line 102.

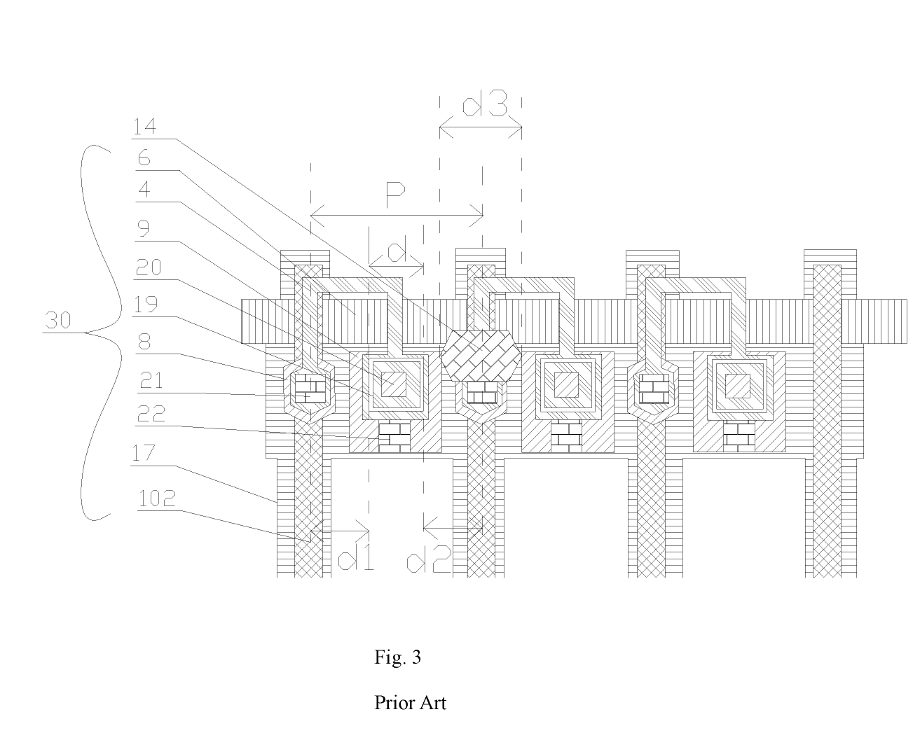

FIG. 3 shows an enlarged drawing of the circle in FIG. 2. It can be seen from FIG. 3 that, a source 8 of the thin film transistor is connected to the data line 102, and a drain 9 of the thin film transistor is connected to the pixel electrode (not shown in FIG. 3). The source 8 is connected to the drain 9 through a channel structure 4. The channel structure 4 runs over the scan line 6. The channel structure 4 runs over the scan line 6 to form a gate of the thin film transistor, thereby controlling the on-off states of the thin film transistor.

In the pixel unit 30, the source 8 of the thin film transistor is connected to the channel structure 4 through a second via 21 hole (ILD hole). The drain 9 of the thin film transistor is connected to the channel structure 4 through a second via hole 22 (ILD hole). Besides, the drain 9 of the thin film transistor is connected to the pixel electrode through a first via hole 19 (PLN hole) and a PL via hole. The first via hole 19 runs through a PLN insulating layer, a common electrode layer and an electrode insulating layer which are arranged between the drain 9 and the pixel electrode (the electrode insulating layer serves to separate the common electrode layer and a pixel electrode layer so as to prevent breakdown).

In the liquid crystal display panel of the prior art, as shown in FIG. 2 and FIG. 3, it is assumed that in the first direction (a horizontal direction in FIG. 2), a size of the pixel unit 30 is p; a width of the first via hole 19 is d; and distances between the first via hole 19 and two ends of the pixel unit 30 in the first direction are respectively dl and d2. It can be obtained that, p=d1+d+d2. A position of the spacer of an upper substrate (a color filter substrate) generally corresponds to a middle of the data line 102. It is assumed that d2 d1, the spacer 14 with size d3 in the first direction in FIG. 2 can easily slide into the first via hole 19 of the pixel unit on a right side, which will lead to unevenness of the liquid crystal cell gap and affect the display effect.

The present application proposes an improved liquid crystal display panel to solve the technical problem mentioned above.

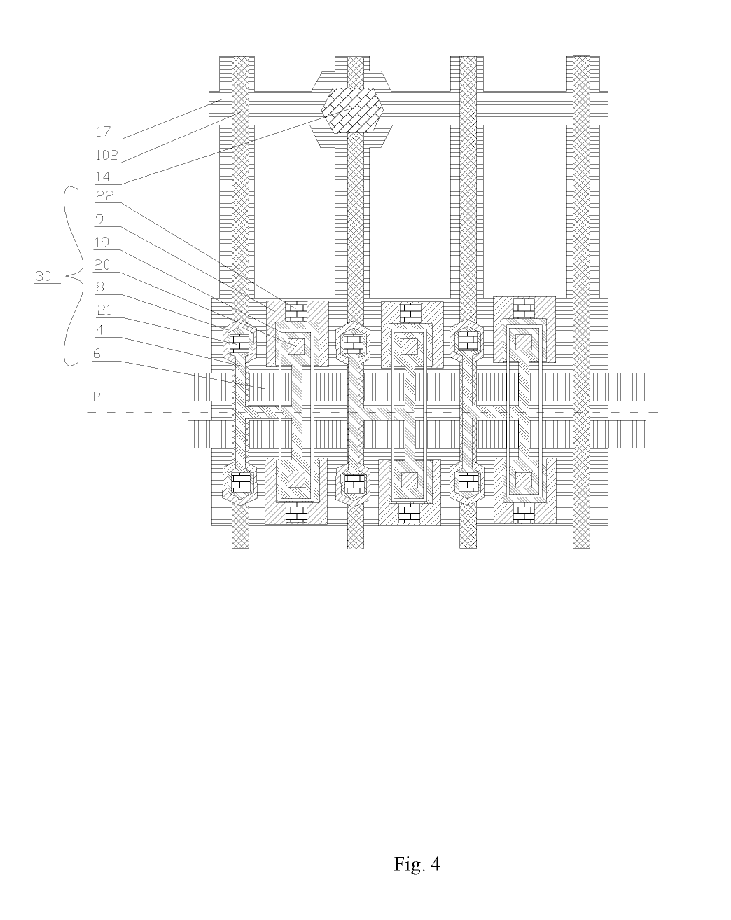

FIG. 4 shows a top view of a partial structure of a liquid crystal display panel according to a first embodiment of the present disclosure. FIG. 4 clearly shows that, according to the first embodiment, an array substrate of a liquid crystal display panel comprises at least two pixel units 30. Each pixel unit 30 comprises a scan line 6 extending along a first direction (a horizontal direction in FIG. 4), a data line 102 extending along a second direction (a vertical direction in FIG. 4) different from the first direction, a pixel electrode (not shown in FIG. 4), and a thin film transistor, which is disposed in a functional connection between the data line 102 and the pixel electrode. A black matrix 17 is provided at positions corresponding to the scan line 6 and the data line 102 for blocking light leakage. The pixel electrode can be disposed in a region surrounded by the scan line 6 and the data line 102.

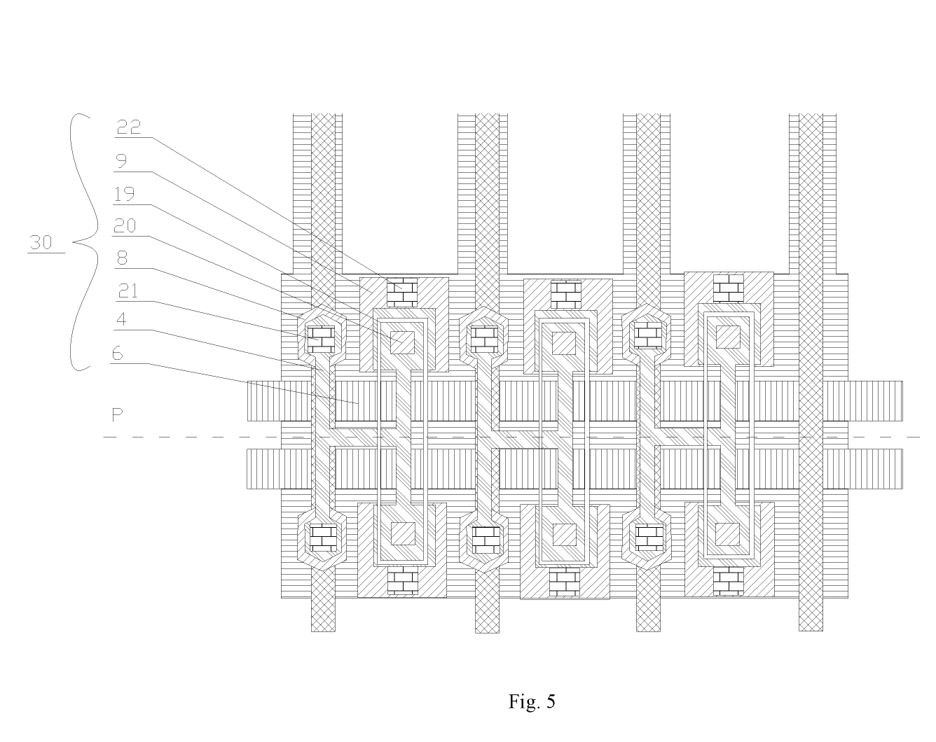

FIG. 5 shows a partial enlarged drawing of FIG. 4. It can be seen from FIG. 5 that, a source 8 of the thin film transistor is connected to the data line 102 and a drain 9 of the thin film transistor is connected to the pixel electrode (not shown in FIG. 5) through a first via hole 19. The source 8 is connected to the drain 9 through a channel structure 4. The channel structure 4 runs over the scan line 6. A material of the channel structure 4 can be Low Temperature Polysilicon with different degrees of doping. The channel structure 4 runs over the scan line 6 to form a gate of the thin film transistor, thereby controlling the on-off states of the thin film transistor.

In the pixel unit 30, the source 8 of the thin film transistor is connected to the Low Temperature Polysilicon 4 through a second via hole 21(ILD hole). The drain 9 of the thin film transistor is connected to the Low Temperature Polysilicon 4 through a second via hole 22 (ILD hole). The drain 9 of the thin film transistor is connected to the pixel electrode through a first vial hole 19 (PLN hole) and a PL via hole.

As shown in FIGS. 4 and 5, in the liquid crystal panel according to a first embodiment of the present disclosure, the two adjacent pixel units 30 in the second direction (the vertical direction in FIG. 4) are mirror-symmetrically arranged such that their scan lines 6 extend in parallel. A symmetry plane P is perpendicular to a surface of the array substrate and parallel to the scan line 6. In FIGS. 4 and 5, the symmetry plane is schematically represented by a dotted line P.

As shown in FIG. 5, in the second direction, extending paths of the channel structure 4 of the two adjacent pixel units 30 are mirror-symmetrically arranged with each other and connected to each other to form an H-shaped pattern together, and the scan line 6 runs over the four opposite edges of the H-shaped pattern.

A color filter substrate of the liquid crystal display panel is provided with a spacer 14 for keeping a liquid crystal gap thereon. It can be clearly seen from FIG. 4 that, a position of the spacer corresponds to one end of the pixel unit of the array substrate in the second direction far from the symmetry plane P.

According to the present embodiment, an n^{th} and an (n+1)^{th} scan lines of two vertically adjacent pixel units are arranged adjacent to each other. For example, a first scan line and a second scan line are arranged adjacent to each other, and a third scan line and a fourth scan line are arranged adjacent to each other. Other scan lines are arranged in a similar manner. The two adjacent parallel extend scan lines respectively control the pixels on a row above and on a row below. Compared with the liquid crystal display panel in the prior art as shown in FIG. 2, a position of the spacer 14 does not change, and the limitation of the first via hole 19 (PLN hole) can be well avoided. The spacer 14 can hardly slide into the first via hole 19 (PLN hole) during assembling of the liquid crystal cell, and uniformity of the liquid crystal gap can be ensured. Besides, compared with the liquid crystal display panel in the prior art as shown in FIG. 2, a distance between the thin film transistors of the two vertically adjacent pixel units 30 is reduced. The first via holes 19 (PLN hole) of the two vertically adjacent pixel units can also be combined into one via hole so that the first via hole passes the drain 9 and the PL via hole 20 of the two adjacent pixel units.

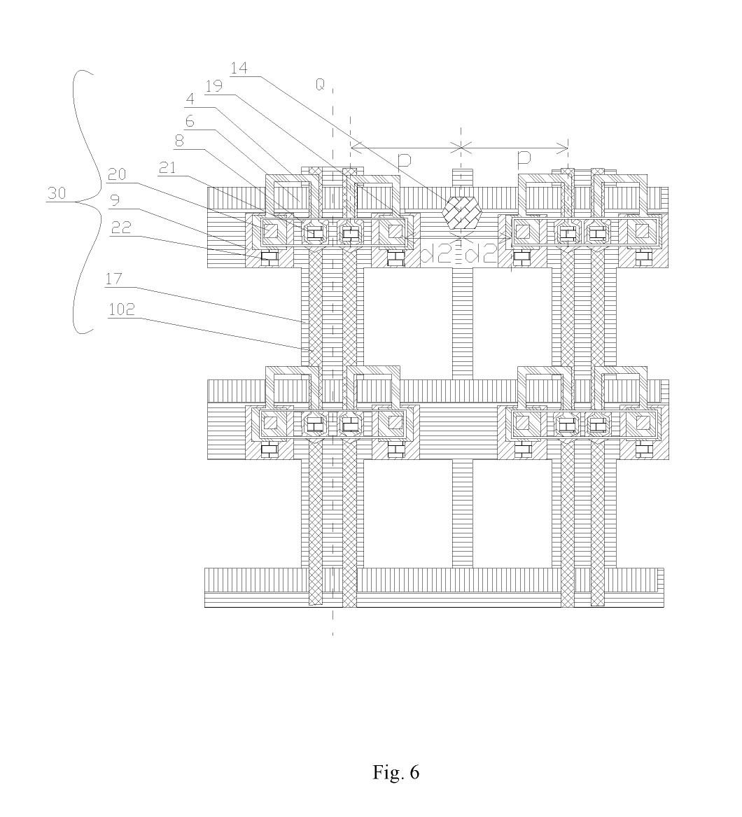

FIG. 6 shows a top view of a partial structure of a liquid crystal display panel according to a second embodiment of the present disclosure. FIG. 6 clearly shows that, according to the second embodiment, an array substrate of the liquid crystal display panel comprises at least two pixel units 30. Each pixel unit 30 comprises a scan line 6 extending along a first direction (a horizontal direction in FIG. 6), a data line 102 extending along a second direction (a vertical direction in FIG. 6) different from the first direction, a pixel electrode (not shown in FIG. 6), and a thin film transistor, which is disposed in a functional connection between the data line 102 and the pixel electrode. A black matrix 17 is provided at a position corresponding to the scan line 6 and the data line 102 for blocking light leakage. The pixel electrode can be disposed in a region surrounded by the scan line 6 and the data line 102.

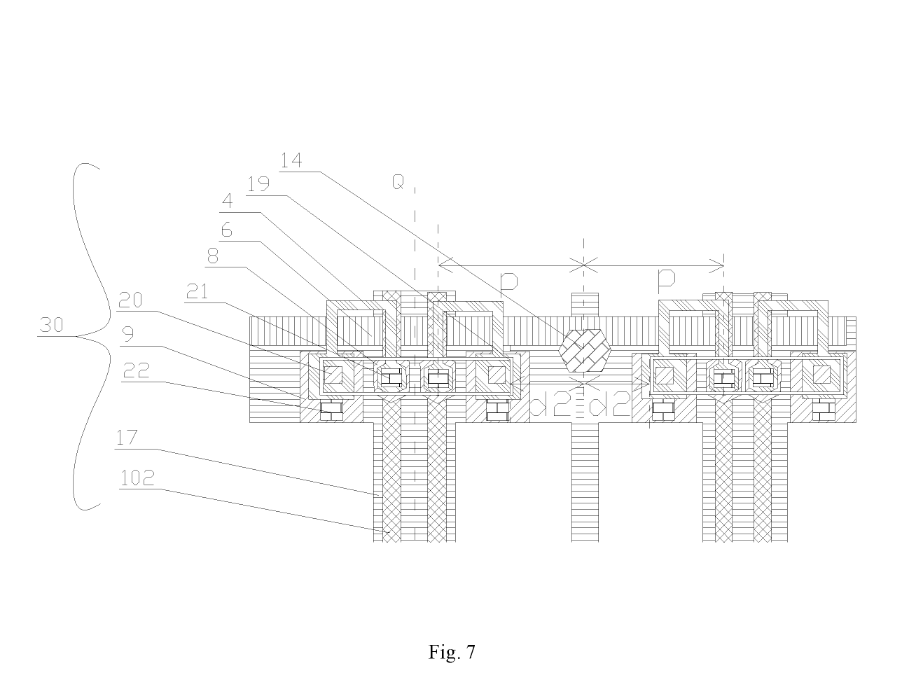

FIG. 7 shows a partial enlarged drawing near the thin film transistor in FIG. 6. It can be seen from FIG. 7 that, a source 8 of the thin film transistor is connected to the data line 102. A drain 9 of the thin film transistor is connected to the pixel electrode (not shown in FIG. 7) through a first via hole 19. The source 8 is connected to the drain 9 through a channel structure 4. The channel structure 4 runs over the scan line 6. A material of the channel structure 4 can be Low Temperature Polysilicon with different degrees of doping. The channel structure 4 passes over the scan line 6 so as to form a gate of the thin film transistor, thereby controlling on-off states of the thin film transistor.

In the pixel unit 30, the source 8 of the thin film transistor is connected to the Low Temperature Polysilicon 4 through a second via hole 21 (ILD hole). The drain 9 of the thin film transistor is connected to the Low Temperature Polysilicon 4 through a second via hole 22 (ILD hole). The drain 9 of the thin film transistor is connected to the pixel electrode through the first vial hole 19 (PLN hole) and a PL via hole 20.

As shown in FIGS. 6 and 7, in the liquid crystal panel according to the second embodiment of the present disclosure, the two adjacent pixels 30 in the first direction (the horizontal direction in FIG. 6) are mirror-symmetrically arranged such that their data lines 102 extend in parallel. A symmetry plane Q is perpendicular to a surface of the array substrate and parallel to the data line 102. In FIGS. 6 and 7, the symmetry plane is schematically represented by a dotted line Q.

A color filter substrate of the liquid crystal display panel is provided with a spacer 14 for keeping a liquid crystal gap thereon. It can be clearly seen in FIG. 7 that, a position of the spacer 14 corresponds to one end of the pixel unit 30 of the array substrate in the first direction far from the symmetry plane Q.

The drain 9 of the thin film transistor is connected to the pixel electrode through the first via hole 19. As shown in the FIG. 6, in the first direction, a size of the pixel unit 30 is p. A distance d2 between the first via hole 19 and the end of the pixel unit 30 far from the symmetry surface Q is preferably larger than an alignment accuracy of a liquid crystal cell. In this manner, the spacer 14 cannot easily slide into the closest first via hole 19 while the liquid crystal cell is assembled.

Specifically, extending paths of the channel structure 4 in the pixel unit 30 form a U-shaped pattern, and the scan line 6 runs over the two opposite edges of the U-shaped pattern. In this manner, the gate of the thin film transistor is formed, thereby controlling on-off states of the thin film transistor.

According to the present embodiment, the data lines of two horizontally adjacent pixel units are arranged adjacent to each other. For example, a first data line and a second data line are arranged adjacent to each other, and a third data line and a fourth data line are arranged adjacent to each other. Other data lines are arranged in a similar manner. A distance between the second data line and the third data line is 2 p. Besides, compared with the liquid crystal display panel in the prior art as shown in FIG. 2, a position of the spacer 14 does not change. At this time, distances between the spacer 14 and the first via holes 19 on both sides are d2. During pixel design, as long as it can be ensured that the value of d2 is larger than the alignment accuracy of the liquid crystal cell, it can be ensured that the spacer 14 will not slide into the first via 19 hole (PLN hole) while the liquid crystal cell is assembled.

Although the present disclosure is described hereinabove with reference to specific embodiments, it can be understood that, these embodiments are merely examples of the principles and applications of the present disclosure. Hence, it can be understood that, numerous modifications can be made to the embodiments, and other arrangements can be made, as long as they do not go beyond the spirit and scope of the present disclosure as defined by the appended claims. It can be understood that, different dependent claims and features described herein can be combined in a manner different from those described in the initial claims. It can also be understood that, the technical features described in one embodiment can also be used in other embodiments.

1. A liquid crystal display panel, wherein an array substrate of the liquid crystal display panel comprises at least two pixel units, and each pixel unit comprises:
a scan line extending along a first direction;
a data line extending along a second direction different from the first direction; and
a thin film transistor, wherein at least a part of the two adjacent pixel units are arranged mirror-symmetrically to each other.

2. The liquid crystal display panel according to claim 1, wherein two adjacent pixel units in the second direction are mirror-symmetrically arranged such that their scan lines extend in parallel, and a symmetry plane is perpendicular to a surface of the array substrate and parallel to the scan line.

3. The liquid crystal display panel according to claim 2, wherein a source of the thin film transistor is connected to the data line while a drain of the thin film transistor is connected to a pixel electrode through a first via hole;
wherein the first via hole runs through an insulating layer and a common electrode layer which are arranged between the drain and the pixel electrode;
wherein the source is connected to the drain through a channel structure; and
wherein the channel structure runs over the scan line.

4. The liquid crystal display panel according to claim 3, wherein in the second direction, extending paths of the channel structure of the two adjacent pixel units are mirror-symmetrically arranged with each other and connected to each other to form an H-shaped pattern together, and the scan line runs over the four opposite edges of the H-shaped pattern.

5. The liquid crystal display panel according to claim 4, wherein the first via holes of the two adjacent pixel units are combined into one via hole so that the first via hole passes the drain of the two adjacent pixel units when viewed in a plan view.

6. The liquid crystal display panel according to claim 2, wherein a color filter substrate of the liquid crystal display panel is provided with a spacer for keeping a liquid crystal gap thereon; and
wherein a position of the spacer corresponds to one end of the pixel unit of the array substrate in the second direction far from the symmetry plane.

7. The liquid crystal display panel according to claim 1, wherein two adjacent pixel units in the first direction are mirror-symmetrically arranged such that their data lines extend in parallel, and
wherein a symmetry plane is perpendicular to a surface of the array substrate and parallel to the data line.

8. The liquid crystal display panel according to claim 7, wherein a source of the thin film transistor is connected to the data line;
wherein a drain of the thin film transistor is connected to a pixel electrode through a first via hole;
wherein the source is connected to the drain through a channel structure; and
wherein the channel structure runs over the scan line.

9. The liquid crystal display panel according to claim 8, wherein the color filter substrate of the liquid crystal display panel is provided with a spacer for keeping a liquid crystal gap thereon; and
wherein a position of the spacer corresponds to one end of the pixel unit of the array substrate in the first direction far from the symmetry plane.

10. The liquid crystal display panel according to claim 9, wherein in the first direction, a distance between the first via hole and the end of the pixel unit far from the symmetry plane is larger than an alignment accuracy of a liquid crystal cell.
